(19) United States
(12) Patent Application Publication
(10) Pub. No.: US 2019/0219157 A1
(43) Pub. Date: Jul. 18, 2019

(54) Transmission Control System

(71) Applicant: ZF Friedrichshafen AG, Friedrichshafen (DE)

(72) Inventors: Harald Stehle, Tettnang (DE); Peter Schiele, Kressbronn (DE); Günther Maier, Meckenbeuren (DE)

(21) Appl. No.: 16/250,258

(22) Filed: Jan. 17, 2019

(30) Foreign Application Priority Data
Jan. 18, 2018 (DE) 10 2018 200 777.2

(51) Int. Cl. F16H 61/02; F16H 61/00; F16H 61/686

(52) U.S. Cl. CPC F16H 61/0204; F16H 59/48; F16H 61/686; F16H 61/0021

(57) ABSTRACT

A method (200) for open-loop control of a gearbox (100) that includes a first and a second proportionally controllable shift element (A-F) is provided. The method (200) includes disengaging the first shift element (A-F) of the gearbox (100) according to a first control profile and engaging the second shift element (A-F) of the gearbox (100) according to a second control profile. The first control profile comprises a variable portion (330) which is increased between a first point in time (t4), when a gradient (335) of the rotational speed of an input shaft of the gearbox (100) reaches a predetermined threshold value, and a second point in time (t5), when the gradient (335) flattens.

### FIELD OF THE INVENTION

The present invention relates generally to a transmission control. In particular, the present invention relates to the open-loop control of a gearbox for use in a motor vehicle.

### BACKGROUND

A motor vehicle includes a drive train which includes a prime mover or drive source, a gearbox, and a driving wheel. Different gear steps or ratios may be engaged in the gearbox in order to adapt a rotational speed of the prime mover to a rotational speed of the driving wheel. The gearbox includes multiple gear sets which may be differently configured and combined with the aid of shift elements. A control device controls the shift elements by way of an open-loop system and, in this way, determines which gear ratio is engaged, i.e., which step-down ratio (or step-up ratio) is present between an input side and an output side of the transmission, and determines with the aid of which gear sets in which configuration the step-down gear is achieved. During a changeover from one gear ratio into another gear ratio, usually at least one shift element is disengaged and another shift element is engaged in order to achieve a changeover which is as smooth as possible.

A shift element is usually hydraulically controlled. If a shift element is acted upon initially with a decreasing control pressure and then with an increasing control pressure, the control pressure may be briefly exceeded by a predetermined amount in order to compensate for a hysteresis of mechanical components and ensure the correct engagement of the shift element. The control device may also include a charging model and a valve model in order to correctly control, by way of an open-loop system, the engagement of the shift element as a function of various parameters.

One problem addressed by the invention is that of providing an improved technique for engaging a shift element.

### SUMMARY OF THE INVENTION

A method for the open-loop control of a gearbox that includes a first and a second proportionally controllable shift element is provided. The method includes disengaging the first shift element according to a first control profile and engaging the second shift element of the gearbox according to a second control profile. The first control profile includes a variable portion which is increased between a first point in time, when a gradient of the rotational speed of an input shaft of the gearbox reaches a predetermined threshold value, and a second point in time, when the gradient flattens.

The shift element may be controlled, for example, with the aid of a hydraulic actuator, wherein a high value of the control profile usually brings about an engagement of the shift element, while a low value brings about a disengagement of the shift element. A high value of the profile corresponds to a high control pressure and a low value corresponds to a low control pressure of the actuator.

An actuator, which is initially activated with a decreasing control pressure and, thereafter, with an increasing control pressure, may have a mechanical play which prevents a precise control, by way of an open-loop system, of the extent of disengagement of the corresponding shift element. In contrast to conventional approaches which provide an adaptation of the control pressure on the basis of a model, an improved adaptation of the control pressure may be carried out by observing the change of the rotational speed of the input shaft of the gearbox. Due to the observation of the speed gradient as a differentiated actual variable, a true closed-loop control may take place, rather than a mere open-loop control. Errors or inaccuracies, which may affect the model, cannot influence the open-loop control.

Thus, an engagement detection may be effectively carried out, with the aid of which it is determined when a mechanical play of the actuation has been used up. Optionally, one further portion of the profile may be determined on the basis of a temperature of the gearbox and/or a torque to be transmitted, for example, with the aid of a characteristic map.

If the actual-pressure profile of the disengaging clutch (p_absist_z) falls below a predetermined pressure value (minimum charge pressure+predetermined offset), offset may be added, as a portion, to the pressure of the disengaging shift element over time as a function of a resultant gradient of the rotational speed of the input shaft.

The gradient of the rotational speed of the input shaft may be ascertained, alternatively, after the start of a controlled powershift or during an active shift pressure phase. The controlled powershift usually includes a static portion of the control profile, which is determined one time before the implementation or application of the control profile.

In order to be able to compare the gradient to a threshold value, a gradient signal ng_tgls may be provided with a filter and may be output as ng_tgls_ff.

In the further course of the gear shift, the gradient of the differential speed of the input shaft with respect to the synchronous speed of the gear step to be engaged (nd_gsynzielgang) may be observed. If the gradient of the input shaft rotational speed flattens, the presently determined pressure value is frozen or constant. The disengagement pressure controlled by an open-loop or closed-loop system may then continue smoothly.

Due to the fact that the actuator rests against the shift element, which is ensured by way of the engagement functionality, a clearly improved pressure sequence behavior in the further course of the gear shift may be ensured.

The variable portion may be initially increased at a high rate until a mechanical play of the shift element has been used up. Thereafter, the variable portion may be further increased, at a lower rate, up to the second point in time.

A device for the open-loop control of a gearbox that includes a first and a second proportionally controllable shift element is provided. The device includes: a first interface for connection to the first shift element; a second interface for connection to the second shift element; and a processing unit. The processing unit is configured for disengaging the first shift element according to a first control profile and engaging the second shift element according to a second control profile. In this case, the first control profile includes a variable portion which is increased between a first point in time, when a gradient of the rotational speed of an input shaft of the gearbox reaches a predetermined threshold value, and a second point in time, when the gradient flattens.

The device may be utilized for carrying out the method described herein. Advantages or features of the method may be transferred to the device, and vice versa.

A shift element may be hydraulically controllable, in particular, with the aid of an electronic pressure regulator. A pressure regulator may include an actuator which carries out an actuation of a shift element as a function of a signal or signal curve. The actuator may operate, in particular, hydraulically, and may include an electronic control valve for the open-loop control of an actuating pressure, and a hydraulic cylinder, in which the actuating pressure acts, as well as a hydraulic piston which is displaceably mounted in the cylinder and acts on the shift element.

### BRIEF DESCRIPTION OF THE DRAWINGS

The invention will now be described more precisely with reference to the attached figures, in which:

FIG. 1 shows a gearbox, for example, for use in a drive train of a motor vehicle;

FIG. 2 shows a flow chart of a method for the open-loop control of a gearbox; and

FIG. 3 shows exemplary profiles of parameters of a gearbox.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

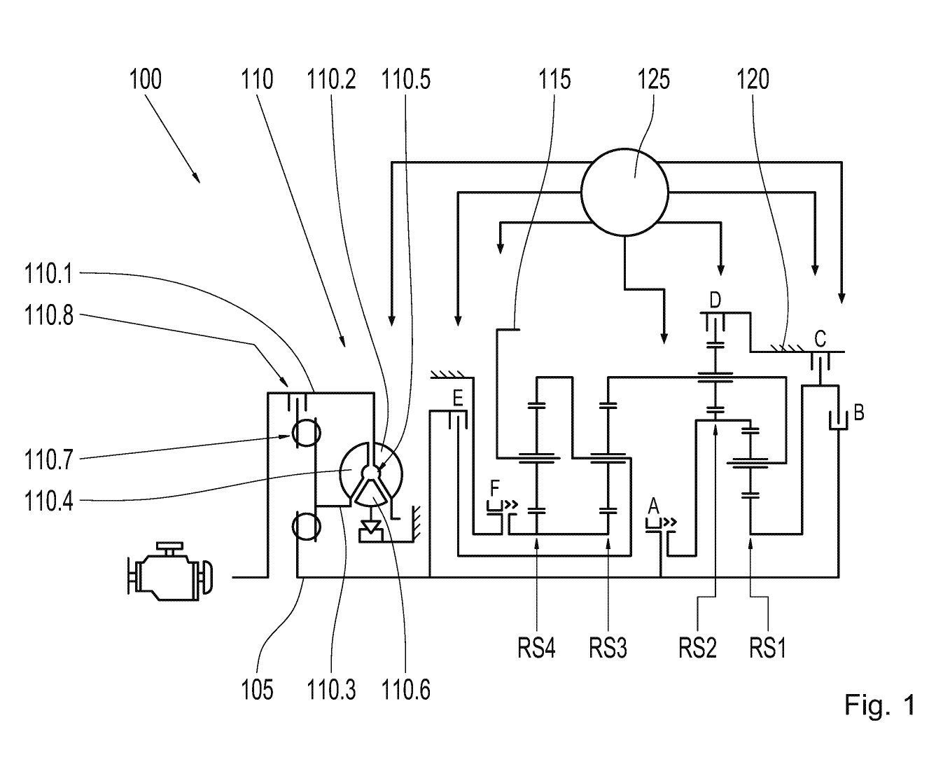

FIG. 1 shows a schematic of an exemplary gearbox 100 which is designed as a multi-stage planetary transmission. A changeover of a gear step or ratio engaged in the gearbox 100 is preferably hydraulically controllable. The present invention is described with reference to the represented gearbox 100, although the present invention may also be utilized on other types of transmissions which permit a controlled engagement or disengagement of a gear ratio.

The gearbox 100 is designed, by way of example, as a 9-speed transmission including one reverse gear and may preferably be utilized in a motor vehicle. The gearbox 100 includes four gear sets RS1 through RS4, each of which may be implemented as an epicyclic system, in particular, in the form of planetary gear trains. An input shaft 105 is configured for connection to a prime mover or drive source. Optionally, a hydrodynamic torque converter 110 is provided between the prime mover and the input shaft 105. The torque converter 110 may be designed to be integral with the gearbox 100 or may be encompassed by the gearbox 100. An output shaft 115 of the gearbox 100 is preferably configured for connection to a driving wheel of the motor vehicle in a torque-transmitting manner.

The hydrodynamic torque converter 110 includes an input side 110.1 which drives a pump 110.2, and an output side 110.3 which is driven by a turbine 110.4. The coupling takes place with the aid of a fluid 110.5 which flows between the pump 110.2 and the turbine 110.4. Preferably, a stator 110.6 is provided in order to direct and, if necessary, control the fluid flow. The torque converter 110 is provided, in particular, as a launch clutch and may bring about an increase in torque depending on a slip between the input side 110.1 and the output side 110.3. A vibration damper 110.7 may be connected to the output side 110.3 in order to reduce torsional vibrations in the torque path. The vibration damper 110.7 may also be provided when the torque converter 110 is dispensed with. Usually, a torque converter lockup clutch 110.8 is provided in order to set the rotational speed difference between the input side 110.1 and the output side 110.3 to zero and, in this way, to minimize flow losses in the torque converter 110, in particular at higher rotational speeds, i.e., after a starting operation.

The gear sets RS1 through RS4 are interconnected in the manner shown, by way of example. Each gear set includes three elements which engage into one another with the aid of tooth systems. The radially innermost element is also referred to as the sun gear, the outermost element is referred to as the ring gear, and the element located therebetween is also referred to as the planet gear. The planet gear is mounted so as to be rotatable with respect to a planet gear carrier which, for its part, is mounted so as to be rotatable about the same axis of rotation as the sun gear and the ring gear. In the representation from FIG. 1, the axis of rotation (not represented) extends horizontally along the input shaft 105. Parts of the gear sets RS1 through RS4 located axially symmetrically below the axis of rotation, as well as their shafts, are not represented. If one of the elements sun gear, planet gear carrier, or ring gear is held, in particular, by way of being braked with respect to a transmission housing 120, the other two elements may be utilized for coupling and decoupling torque, wherein a predetermined step-up or step-down ratio is achieved.

For the open-loop control of a torque flow through the gear sets RS1 through RS4, a total of six shift elements A through F are available in the represented embodiment, each of which may be activated to be disengaged or engaged. The shift elements C and D each operate between a rotary element and the transmission housing 120 and are also referred to as brakes. The shift elements A, B, E and F each operate between two rotary elements and are also referred to as clutches. At least one of the shift elements A through F is preferably configured for being capable of disconnecting or connecting, in a proportionally controllable manner, a torque connection between a completely disengaged position and a completely engaged position. For this purpose, friction elements may be provided, which are pressed axially against one another in order to establish a variable frictional connection. An axial contact force may be brought about, in particular, hydraulically, for the purpose of which, for example, an electronic pressure regulator may adjust a hydraulic control pressure according to a control signal in order to control the level of the torque transmission.

In the present embodiment, at least the shift elements B to E are proportionally controllable in terms of their transmission behavior. The shift elements A and F, in particular, may be designed as form-fit shift elements which may only be completely disengaged or completely engaged. The following table shows an exemplary shift pattern. For each gear step, shift elements A through F which are engaged in order to engage the gear step are marked with a dot. The other shift elements A through F are disengaged.

| Gear | | | | | | |
|---|---|---|---|---|---|---|
| step | C | D | B | E | F | A |
| 1 | | ● | | | ● | ● |
| 2 | ● | | | | ● | ● |
| 3 | | | ● | | ● | ● |
| 4 | | | | ● | ● | ● |
| 5 | | | ● | ● | | ● |
| 6 | ● | | | ● | | ● |
| 7 | | ● | | ● | | ● |
| 8 | ● | ● | | ● | | |
| 9 | | ● | ● | ● | | |
| R | | ● | ● | | ● | |

A changeover from an engaged gear step to another gear step requires the disengagement of at least one engaged shift element A through F and the engagement of at least one disengaged shift element A through F.

If, for example, the second gear step is engaged in the gearbox, torque is transmitted from the input shaft 105 via the shift element A to the ring gear of the first gear set RS1. The sun gear of the first gear set RS1 is connected to the housing 120 via the shift element C. The shift element D is disengaged, and so the second gear set RS2 transmits no torque. The torque made available by the first gear set RS1 at the planet gear carrier of the first gear set RS1 is transmitted to the ring gear of the third gear set RS3. Sun gears of the third gear set RS3 and of the fourth gear set RS4 are connected to the housing 120 via the shift element F. Torque is coupled from the planet gear carrier of the third gear set RS3 into the ring gear of the fourth gear set RS4. The output shaft 115 is driven by the planet gear carrier of the fourth gear set RS4.

In order to now engage the third gear step, the shift element B is engaged and the shift element A is disengaged. The functions of the gear sets RS2 through RS4 remain unchanged. As in the second gear step, the first gear set RS1 is driven via the ring gear and torque is made available via the planet gear carrier. The sun gear is now connected via the shift elements A and B to the ring gear, however, and so the step-down ratio of the first gear set RS1 is set to one.

In order to ensure a high level of shifting comfort or a high shifting speed, the condition changes at the shift elements A through F must be more precisely matched to one another. During a gear step changeover, two gear steps are usually intermittently simultaneously engaged and transmit torque, wherein at least one of the shift elements A through F is in the slip condition.

A control device 125 is configured for appropriately disengaging and engaging the shift elements A through F and, in this way, engaging a desired gear step in the gearbox 100. The shift elements A through F are usually hydraulically actuated, wherein a disengagement or engagement force and a disengagement or engagement position of a shift element A through F depend on an applied hydraulic pressure. An electronic pressure regulator is usually assigned to each shift element A through F for the open-loop control of the hydraulic pressure. A pressure regulator converts a predefined, usually electrical signal into a corresponding hydraulic pressure and may operate in the manner of a proportional valve, a control valve, or servo-valve. The control device 125 operates preferably electrically and may include a programmable microcomputer or microcontroller. A signal made available at an electronic pressure regulator may be present as a pulse-width modulated (PWM) signal.

The control device 125 determines control signals to be set for the shift elements A through F usually with respect to an event, the time, or a transmission parameter which may be sampled with the aid of a suitable sensor. Transmission parameters may include, for example, rotational speeds at different points of the gearbox 100, a hydraulic pressure, a torque to be made available or to be transmitted, a temperature, or a position of a shift element A through F. An event may be derived from one sampled parameter or from a combination of multiple sampled parameters. For example, it may be determined that a synchronization point is no longer met when a slip sets in at a shift element A through F and the friction elements have different rotational speeds. The fact that the synchronization point is no longer met may also be determined on the basis of a ratio of rotational speeds of the input shaft 105 with respect to the output shaft 110. If the ratio does not match a predetermined reduction ratio of a gear step, the synchronization point of this gear step is not met. An event may also be determined with reference to an external parameter, for example, when a signal regarding a changed driver demand, a changed operation of the prime mover, or a change in the drive train between the output shaft 115 and a driving wheel is acquired.

The processing unit 125 may predefine the hydraulic control pressure to be set for a shift element A through F in the form of a curve over time, which is also referred to as a control profile or gradient. For a predetermined sequence in the gearbox 100, for example, the changeover from the third gear step into the second gear step, multiple profiles, which are matched to each other, for the shift elements A through F are usually determined and made available. A changeover of the gear step may require a time of approximately a quarter (¼) second or less. Under certain circumstances, however, a changeover of the gear step may be extended for a longer time. A control profile may be composed of multiple portions which may be additively combined with one another. A portion may be static, in part or completely, when it is dependent only on time and not on an event or a parameter. A portion may also be dynamic when there is a dependency on an event or a parameter. In this case, the control profile may be determined or changed while the control profile is already being utilized for the open-loop control of a shift element A through F. For example, a first portion may ensure the desired functionality in the first approximation, a second portion may represent a refinement, such as an increase in comfort, and a third portion may implement a further optimization in a special case, for example, during downshifting accompanied by a brake application at a driving wheel.

In order to assist the changeover of the engaged gear step, a demand to limit the torque provided by the prime mover to a predetermined value may also be transmitted to the prime mover connected to the input shaft 105.

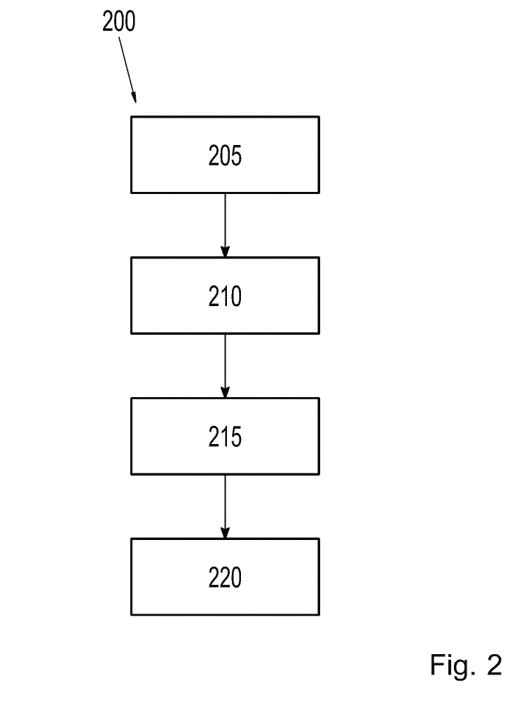

FIG. 2 shows a flow chart of a method 200 for the open-loop control of a gearbox 100, in particular, for engaging a shift element A through F. The method 200 is preferably configured for execution on the control device 125 and may be present as a computer program product including program code for the open-loop control of the gearbox 100. The method 200 may be carried out, in particular, within the scope of a gear step changeover when a first shift element A through F of the gearbox 100 is disengaged and a second shift element A through F of the gearbox 100 is engaged in parallel thereto. The shift element A through F considered in the following is that shift element which is disengaged within the scope of the gear step changeover, and so the shift element no longer transmits torque.

At 205, it is determined whether a predetermined start condition has been met. For this purpose, a check may be carried out to determine whether a demand (SWI_KAB_ANLEGEN) to engage the shift element A through F is present. If the demand is present, in the case of an activated controlled powershift, the condition of the shift element A through F may also be determined for subsequent use.

In addition, it may be determined whether the condition p_absist_z−p_fmin_z<PS_KAB_ANLEGEN applies and/or whether the condition ng_dsynzielgang>KF_NGS_KAB_ANLEGENCGMTxy has been met. KF_NGS_KAB_ANLEGENCGMTxy refers, in this case, to the gradient of nd_syn. If the shift element A through F includes a dog clutch, it may also be determined that the condition schaltung_ueber_kzu=FALSE has been met.

If all conditions checked at 205 have not been met, the special function for engaging the shift element A through F described herein may remain inactive. Otherwise, at 210, the engagement of the shift element A through F may be controlled by an open-loop system. For this purpose, in particular, the control profile determined for the shift element A through F may be additively mixed with an additional portion. The additional portion is preferably determined with the aid of a characteristic curve. Input variables of the determination may include KF_PORAKABANLEGENCGxy and/or a function which is dependent on timer_zkab_anlegen and c_getr. The function may be implemented with the aid of a characteristic map.

While the engagement function is active, a check may be carried out at 215 to determine whether one or multiple stop conditions has/have been met. The shift pressure phase is usually terminated by way of a lead time KL_TSYNMTKABxy before synchronization. If the regulator changeover pressure p_fmin_z is reached, zero may be output for the absolute pressure. When the closed-loop control changes over again to the engaging or disengaging shift element A through F, an operative mechanism of the shift element A through F, for example, a hydraulic piston, is engaged once again by way of the implementation of a rapid charging. The time duration of the rapid charging may be determined on the basis of a charging model. During the rapid charging, the operative pressure of the shift element A through F is limited to zero in order to prevent the closed-loop control from drifting and, after the end of the rapid charging, the operative pressure is abruptly set to the calculated shift pressure.

A stop condition may be met when the determined control profile for the shift element A through F exceeds a predetermined threshold value PS_MAX_ANLEGEN. Another stop condition may be met when the change of the rotational speed of the input shaft 105 (turbine gradient) begins to decrease once again. In other words, the condition may be met when the following applies: ng_tgls_ff+KF_NGXS_KAB_ANLEGENCG f(n_tkf; c_getr)<ng_tgls_old_kab_anlegen. If at least one of the stop conditions has been met, the special function of the engagement of the shift element A through F may be terminated. In this case, for the purpose of termination, a present value of the additional portion determined at 210 (KF_PORAKAB_ANLEGEN_xy) may be frozen at 220. Subsequent thereto, the value of the additional portion applicable at this point in time is additively mixed with the control profile. The value is no longer changed, however, at least up to the point of the termination of the gear change phase.

If an additional function HINSYN is active at 210, in order to hold the shift element A through F at a synchronization point, the shift pressure phase may be terminated by way of the lead time before synchronization, as is the case for the engaging shift element A through F (KF_TSYNCGMTHINSYNxy). If the regulator changeover pressure p_fmin_z has been reached, this pressure may be held. If the closed-loop control changes over again to the disengaging shift element, the closed-loop control preferably starts at this pressure. The closed-loop control by way of the controlled powershift may become active up to the synchronization point.

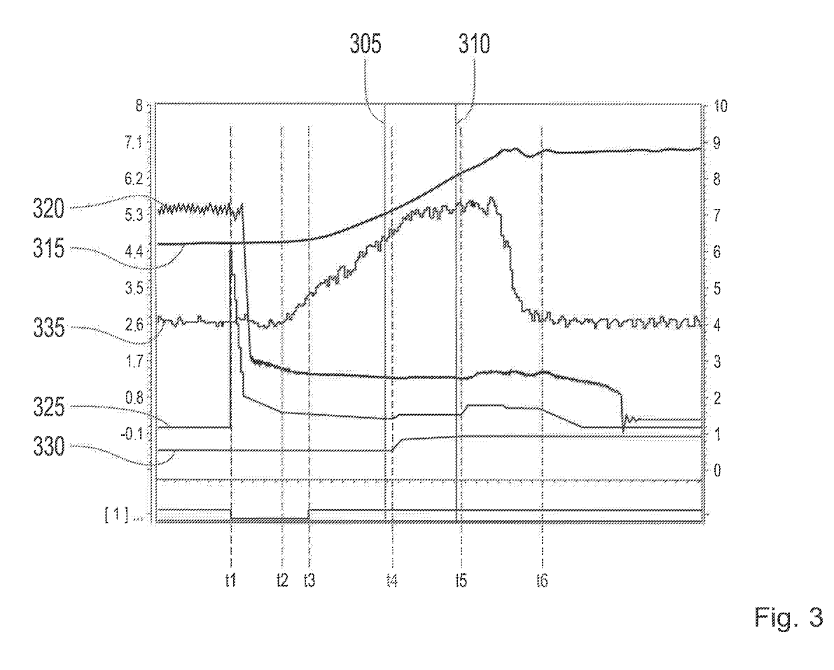

FIG. 3 shows exemplary profiles 300 of parameters with respect to a gearbox 100. Curves over time are graphically represented in a range on the left. Absolute values of variables of the gearbox 100 at a first point in time 305 and at a second point in time 310 are expressed numerically in a range on the right. The represented values were determined on a real, exemplary gearbox 100 during a gear shift, which was also exemplary, from a third gear step into a second gear step.

A first profile 315 reflects the rotational speed of the input shaft 105. A second profile 320 represents the absolute shift pressure sampled at a shift element A through F. A third profile 325 (p_kab) relates to the specified pressure to be applied at the shift element A through F of the second profile 320. A fourth profile 330 relates to an additional portion (po_kab_anlegen) which is to be added to the profile 325. A fifth profile 335 relates to a gradient of the rotational speed of the input shaft 105, i.e., a time derivative of the first profile 315. Vertical scales of the represented profiles may be scaled and/or shifted in order to facilitate comparisons.

A gear step changeover begins at a point in time t1, namely the replacement of the third gear step by the second gear step in this case, by way of example. At this point, a high control pressure is present at the shift element A through F in order to hold the shift element in the engaged position, and the specified pressure 325 is irrelevant. At the point in time t1, the specified pressure 325 and the shift pressure 320 of the shift element A through F to be disengaged rapidly drop from high values until, at a point in time t2, a predetermined shift pressure has been reached or fallen below. Shortly thereafter, at a point in time t3, a synchronization point of the third gear step is no longer met, due to the fact that a speed ratio via the gearbox 100 no longer corresponds to the predetermined reduction ratio of the third gear step. At a point in time t4, immediately after the first point in time 305, the gradient condition for the activation of the engagement detection is met, due to the fact that the gradient 335 of the rotational speed of the input shaft 105 exceeds a predetermined threshold value and the following applies: ng_dsynzielgang>KL_NGS_ANLEGENCG.

Thereupon, the engagement control becomes active and the portion 330 to be added to the third profile 325 is increased with a predetermined gradient. This brings about a minimal increase of the measured shift pressure 320 when mechanical tolerances of the shift element have been used up. At a point in time t5, immediately after the second point in time 310, the gradient 335 of the rotational speed of the input shaft 105 has been flattened to such an extent that the gradient 335 falls below a further predetermined threshold value. Thereupon, the increase of the portion 330 is terminated and the existing value of the portion 330 is frozen.

At the point in time t5, in addition, a HINSYN function becomes active, which holds the gearbox 100 at a predetermined synchronization point. The specified pressure 325 is increased, which brings about a time-delayed increase of the measured shift pressure 320. The input shaft 105 is effectively decelerated by way of the increase, as is apparent on the basis of the gradient 335. At a point in time t6, the function HINSYN ends. The specified pressure 325 of the shift element A through F is subsequently decreased at a predetermined rate.

Modifications and variations can be made to the embodiments illustrated or described herein without departing from the scope and spirit of the invention as set forth in the appended claims.

### REFERENCE CHARACTERS

100 gearbox
105 input shaft
110 hydrodynamic torque converter
110.1 input side
110.2 pump
110.3 output side
110.4 turbine
110.5 fluid
110.6 stator
110.7 vibration damper
110.8 torque converter lockup clutch
115 output shaft
120 transmission housing
125 control device
A-F shift element
200 method
205 Start condition met?
210 open-loop control
215 Stop condition met?
220 open-loop control
300 profiles
305 first point in time
310 second point in time
315 rotational speed of input shaft
320 shift pressure of shift element
325 specified pressure of shift element
330 additional component
335 gradient of the rotational speed of the input shaft

1-5. (canceled)

6. A method (200) for open-loop control of a gearbox (100) that includes a first proportionally controllable shift element (A-F) and a second proportionally controllable shift element (A-F), the method (200) comprising:
disengaging the first shift element (A-F) of the gearbox (100) according to a first control profile; and
engaging the second shift element (A-F) of the gearbox (100) according to a second control profile,
wherein the first control profile comprises a variable portion (330) which increases between a first point in time (t4) and a second point in time (t5), a gradient (335) of a rotational speed of an input shaft of the gearbox (100) reaches a predetermined threshold value at the first point in time (t4), and the gradient (335) flattens at the second point in time (t5).

7. The method (200) of claim 6, wherein the variable portion (330) is constant after the second point in time (t5).

8. The method (200) of claim 6, wherein the variable portion (330) increases at a higher rate until a mechanical play of the second shift element (A-F) is depleted and, thereafter, increases up to the second point in time (t5) at a lower rate.

9. A device (125) for open-loop control of a gearbox (100) that includes a first proportionally controllable shift element (A-F) and a second proportionally controllable shift element (A-F), the device comprising:
a first interface for connection to the first shift element (A-F);
a second interface for connection to the second shift element (A-F);
a processing unit (125); and
a memory storing computer-executable instructions that, when executed by the processing unit (125), cause the processing unit (125) to perform operations comprising
disengaging the first shift element (A-F) according to a first control profile; and
engaging the second shift element (A-F) according to a second control profile,
wherein the first control profile comprises a variable portion (330) which increases between a first point in time (t4) and a second point in time (t5), a gradient (335) of the rotational speed of an input shaft of the gearbox (100) reaches a predetermined threshold value at the first point in time (t4), and the gradient (335) flattens at the second point in time (t5).

10. The device of claim 9, wherein the first and second shift elements (A-F) are hydraulically controllable via electronic pressure regulators.
